(19) United States
(12) Patent Application Publication
(10) Pub. No.: US 2014/0195326 A1
(43) Pub. Date: Jul. 10, 2014

(54) System and Method for Rebate Queue Management

(71) Applicants: Li Men, Richmond (CA); Boxu Men, Richmond (CA)

(72) Inventors: Li Men, Richmond (CA); Boxu Men, Richmond (CA)

(21) Appl. No.: 13/737,013

(22) Filed: Jan. 9, 2013

(51) Int. Cl. G06Q 30/02

(52) U.S. Cl. CPC G06Q 30/0234
USPC 705/14.34

(57) ABSTRACT

A rebate queue management system comprises a seller end, a buyer end, a payment module end, a transaction extraction unit, a discount extraction unit, a rebate calculation unit, a sorting unit coupled to the rebate calculation unit, a queue unit coupled to the sorting unit, and a rebate unit coupled to the queue unit. Once the queue number in a currency subunit queue accumulates to n times of the cycle number of the queue, the system releases one rebate to the buyer of the transaction associated with the n^{th} queue number, wherein n is a natural number. A method for managing rebate queues is also provided.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The present invention is directed to a rebate queue management system and a method for managing rebate queues useful in processing transactions. More specifically, the present invention concerns a system and method, applicable to the Internet, mobile Internet, electronic commerce, merchandise circulation, and gambling industry, wherein transactions are sorted by currency values and enqueued to respective queues for rebates.

In traditional commerce, sellers (merchants) utilize promotional means, such as discounts, sweepstakes, and gifts, to stimulate buyers' purchasing desire and to boost merchandise sales. Take plane tickets for instance, retailers could use the commissions they receive from airline companies to increase the discount rate on their plane tickets and to therefore sustain the low-price advantage. In this way, retailers are able to offer discounts to buyers and expand their sales at the same time. However, traditional promotions do not offer direct rebates to buyers.

To improve promotional effectiveness further, promotional methods offering buyers cash returns by holding rebate queues have emerged consequently. Sellers have gradually accepting these newer promotional methods due to their easy operability.

Different formats of rebate operations are currently in commercial use, such as rebate cards, which has been implemented in some rebate queuing websites on the Internet.

However, in the rebate card format, the process begins with rebate queue platform operators printing out rebate cards which are sold to contracted sellers under certain rates. The sellers will then give out those rebate cards to buyers of their merchandise. After receiving the rebate cards, buyers are still required to log back onto the website platform to type in the numbers and passwords printed on the cards in order for their transactions to officially enter the rebate queue system. This entire procedure is extremely complex, inconvenient, and time-consuming, and does not effectively utilize the straightforwardness, convenience, and efficiency of an e-commerce platform.

In addition to the rebate queue format mentioned above, a mode of direct rebate exists in current e-commerce application. In this mode, buyers are guided to allied sellers' websites by clicking on the website entrances placed by the rebate platform operators on their website; after completing the purchases, buyers are directed back to the rebate platform website to obtain any rebates. Queue, a mechanism for stimulating consumer demands, is not introduced in this particular mode of rebate; as a result, the amounts of rebates sellers could offer are relatively small and are less attractive to buyers. The fact that buyers are required to enter sellers' shopping platforms only through the rebate website in order to receive purchasing returns works against the common purchasing habits of most buyers (in other words, most buyers tend to search their merchandise of interest directly while shopping online, instead of looking for the website entrances on the rebate platform first). This also causes inconvenience to buyers who are more time-sensitive or have immediate purchasing needs. In addition, poor user experience and transaction security may result from buyers having to frequently jump between the rebate platform and allied sellers' websites during shopping. Furthermore, offline sellers are excluded from this mode of rebate. In sum, several problems still need to be addressed to improve this rebate method.

Accordingly, no rebate methods available to date can effectively process transactions from different categories and different prices, nor can they combine online and offline transactions.

### BRIEF SUMMARY OF THE INVENTION

The present disclosure describes a system and method for managing rebate queues.

In a first embodiment, the invention provides a rebate queue management system comprising a seller end, a buyer end, a payment module end, a transaction extraction unit and a discount extraction unit both coupled to the seller end and a rebate calculation unit, a sorting unit coupled to the rebate calculation unit, a queue unit coupled to the sorting unit, and a rebate unit coupled to the queue unit, wherein the system release one rebate to the buyer of the transaction associated with the n^{th} queue number once the queue number in a queue accumulates to n times of the cycle number of the queue, wherein n is a natural number.

In a second embodiment, the invention provides a computer-implemented method for managing rebate queues comprising extracting a transaction total from an invoice, extracting a discount rate associated with the transaction total, calculating a rebate total based on the extracted transaction total and the extracted discount rate, sorting the calculated rebate total into numerical digits by subunits of the currency, enqueuing the sorted numerical digits to respective queues of the currency subunits, and releasing one rebate to the buyer of the transaction associated with the n^{th} queue number once the queue number in the queue accumulates to n times of the cycle number of the queue, wherein n is a natural number.

Further advantageous embodiments of the invention have been specified in the dependent claims and will become apparent by reference to the following description taken in connection with the accompanying drawings.

### BRIEF DESCRIPTION OF THE SEVERAL VIEWS OF THE DRAWINGS

The preferred embodiments of the invention will in the following be further described, in a non-limiting manner, and with reference to the accompanying drawings, in which:

FIG. 1a illustrates a rebate queue management system to which embodiments of the present invention relate.

FIG. 1b illustrates a variation of the rebate queue management system of the present invention.

FIG. 1c illustrates another variation of the rebate queue management system of the present invention.

FIG. 1d illustrates yet another variation of the rebate queue management system of the present invention.

FIG. 2 is a flow chart describing a method for managing rebate queues in accordance with an embodiment of the present invention.

FIG. 3 is a flow chart describing a method of retrieving user's rebate records in accordance with an embodiment of the present invention.

FIG. 4 schematically illustrates the transaction procedures according to the rebate queue management system of the present invention.

### DETAILED DESCRIPTION OF THE INVENTION

The present disclosure applies to online B2B, B2C, C2C transactions, and traditional offline buyer-seller transactions, as well as gambling transactions, and may be combined with traditional cashier systems and online shopping systems, so that once a customer completes a transaction either from online or with a traditional offline seller, the transaction details can automatically enter the rebate queue management system. The present disclosure integrates shopping, queue, and rebate processing into an all-in-one system, and innovates a novel mode of commercial promotion.

The following provides a detailed description of the embodiments of the present invention. Please note that the embodiments described herein are merely exemplary and are not meant to limit the scope of the present invention.

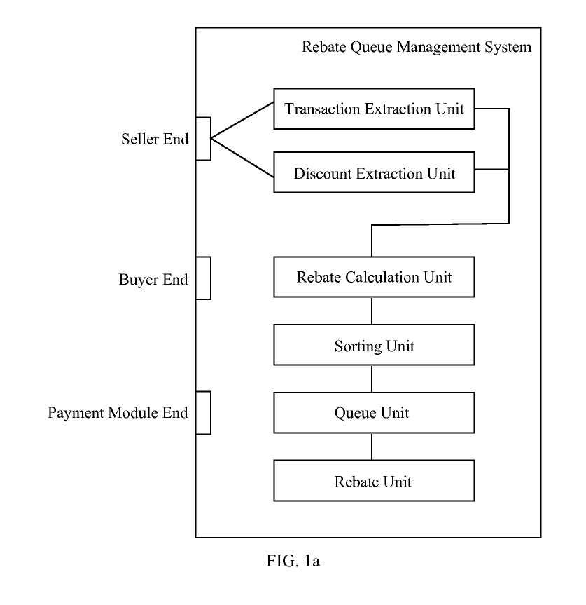

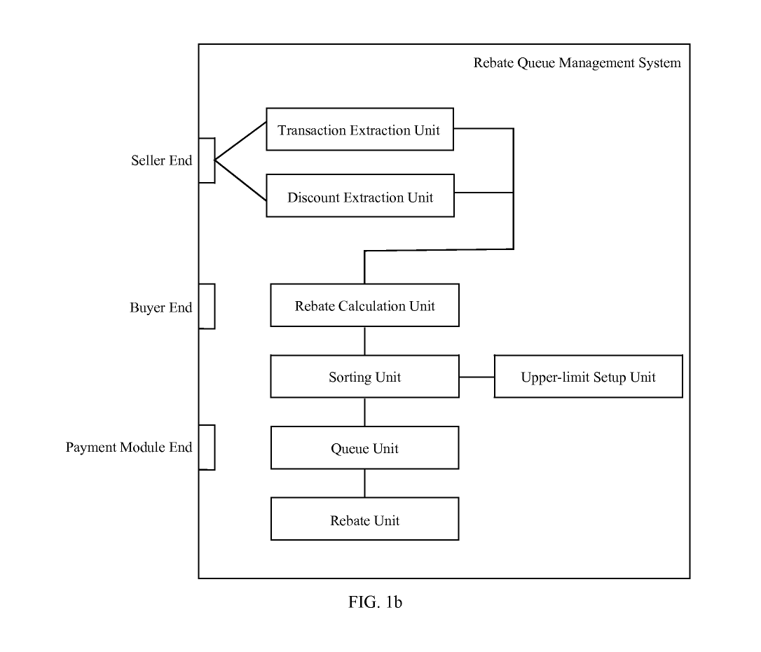

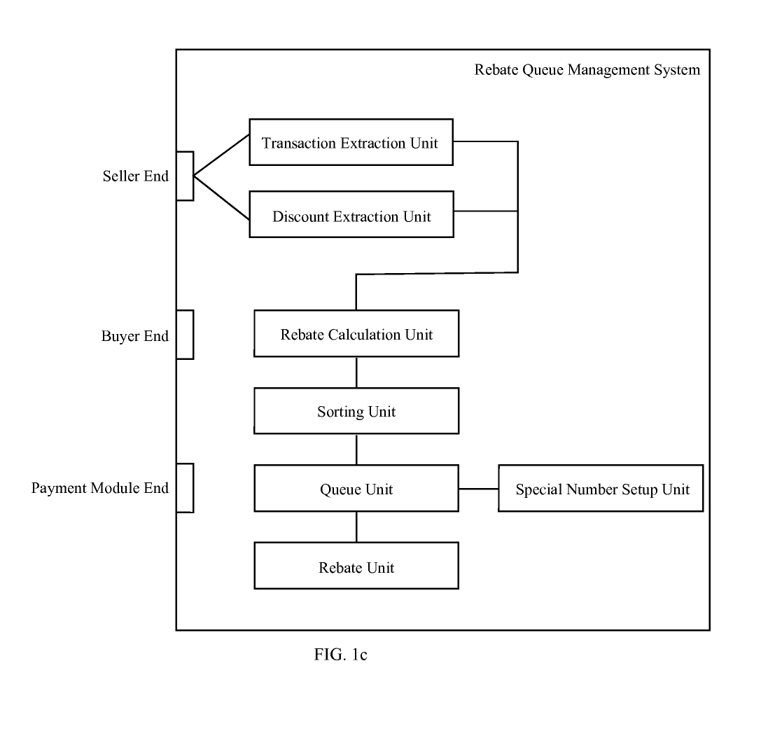

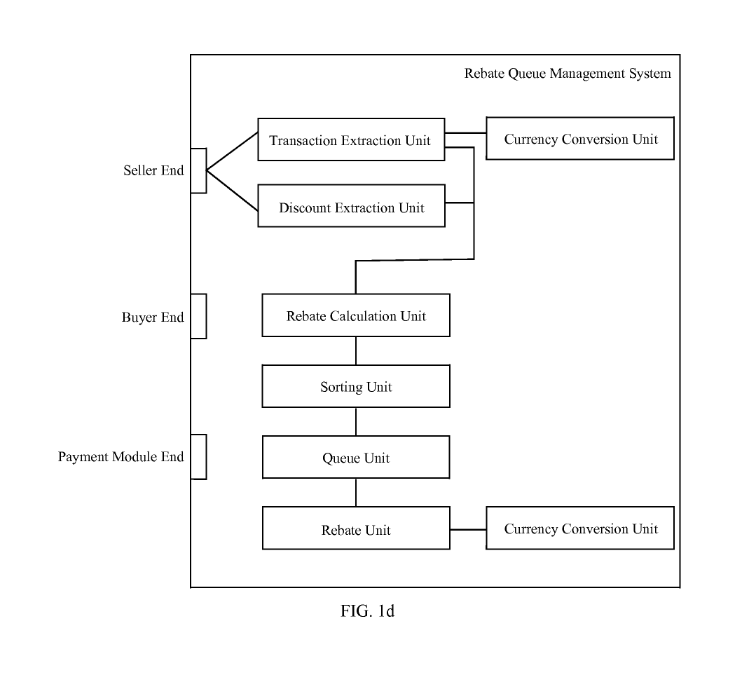

Referring now to FIG. 1, which illustrates a rebate queue management system to which embodiments of the present invention relate.

As shown in FIG. 1, the rebate queue management system of the present invention comprises a seller end, a buyer end, a payment module end, a transaction extraction unit, a discount extraction unit, a rebate calculation unit, a sorting unit, a queue unit, and a rebate unit;

The seller end communicates with sellers via the Internet, and receives data on transaction details and the associated discount rates sent from the sellers;

The buyer end communicates with buyers via the Internet;

The payment module end communicates with payment modules with online banking or electronic fund transferring capabilities via the Internet;

The transaction extraction unit is coupled to said seller end and is adapted for extracting the transaction total from the invoice;

The discount extraction unit is coupled to said merchant end and is adapted for extracting the discount rate associated with the transaction total, wherein said discount rate falls between the range of 0.1%-99.9%, inclusive;

The rebate calculation unit is coupled to said transaction extraction unit and said discount extraction unit and is adapted for calculating the rebate total based on the transaction total extracted by said transaction extraction unit and the discount rate extracted by said discount extraction unit;

The sorting unit is coupled to said rebate calculation unit and is adapted for sorting the rebate total calculated by said rebate calculation unit into numerical digits by subunits of the currency, which may include, but not limited to, hundredth, tenth, one-dollar, ten, hundred, thousand, ten-thousand, hundred-thousand, million, ten-million, hundred-million, and billion;

The queue unit is coupled to said sorting unit and is adapted for enqueuing the numerical digits sorted by said sorting unit to respective queues of the currency subunits; the value of each sorted numerical digit equals the additional queue number(s) enqueued to the respective queues of the currency subunits, wherein the queue number adds up on the previous queue number and increases in accordance with the order of natural numbers;

The rebate unit is coupled to said queue unit and is adapted for releasing one rebate to the buyer of the transaction associated with the n^{th} queue number once the current largest queue number reaches n times of the cycle number of the queue, wherein n is a natural number and said cycle number may be any natural number that is larger than 1. The form of rebate released to the buyer by said rebate unit may include, but not limited to, cash, virtual currency, and credit, which may be used for any future transactions.

With further reference to FIG. 1, said seller end comprises hardware on the seller end and software on the seller end implemented on the hardware on the seller end. Said hardware on the seller end may include, but not limited to, desktop computers, tablet computers, and Point-of-Sale (POS) devices; while said software on the seller end may include computer-executable programming codes associated with, but not limited to, customer information inquiries, transaction inquiries, generation and delivery of invoices, rebate inquiries, and relevant statistical analyses. Similarly, said buyer end comprises hardware on the buyer end and software on the buyer end implemented on the hardware on the buyer end. Said hardware on the buyer end may include, but not limited to, desktop computers, tablet computers, and smartphones; while said software on the buyer end may include computer-executable programming codes associated with, but not limited to, addition, deletion, revision, and tracking of information on the membership accounts, transaction inquiries, and rebate inquiries.

Again with reference to FIG. 1, said seller end comprises online and offline transactions from the seller end and is adapted for verifying customer's membership status and uploading transaction details. Meanwhile, said buyer end comprises an input device adapted for entering account information, purchasing records, and search terms and a display device adapted for displaying transaction details and the queue and rebate statuses of the transactions; these settings facilitate buyer's access to the rebate queue management system and the related transaction records.

Referring now to FIG. 1b, which illustrates a variation of the rebate queue management system of the present invention. As shown in FIG. 1b, the rebate queue management system of the present invention further comprises an upper-limit setup unit coupled to said sorting unit and adapted for defining a currency subunit as the upper-limit, which may include, but not limited to, thousand, ten-thousand, hundred-thousand, million, ten-million, and hundred-million. Numerical digits associated with any currency subunits larger than the upper-limit are divided and sorted into the upper-limit subunit; the sorted digits are then enqueued to the queue of the upper-limit subunit.

Referring now to FIG. 1 c, which illustrates another variation of the rebate queue management system of the present invention. As shown in FIG. 1c, the rebate queue management system of the present invention further comprises a special number setup unit coupled to said queue unit and adapted for presetting at least one special number in one or more of the subunit queues. Once the queue number reaches one of the special numbers, said rebate unit directly release one rebate to the buyer of transaction associated with that queue number and does not twice rebate the buyer when that queue number later becomes qualified for a rebate under regular queuing conditions.

Referring now to FIG. 1d, which illustrates yet another variation of the rebate queue management system of the present invention. As shown in FIG. 1d, the rebate queue management system of the present invention further comprises a currency conversion unit coupled to said transaction extraction unit and said rebate unit and adapted for converting the currency of transaction extracted by said transaction extraction unit to the common currency used in the area based on the real-time currency exchange rate while transaction on the invoice involves a currency that is different from the common currency used in the area, and releasing converting the common currency back to the currency of the original transaction based on the real-time currency exchange rate before releasing a rebate to the buyer by said rebate unit.

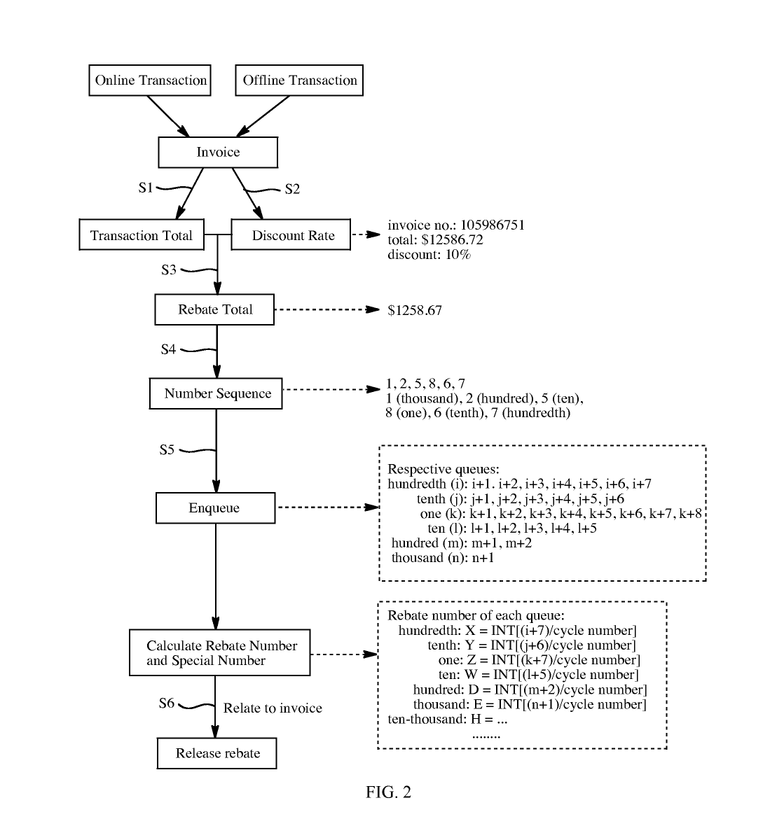

Referring now to FIG. 2, which shows a flow diagram describing the procedural steps in accordance with an embodiment of the present invention. As shown in FIG. 2, the method for managing rebate queues according to the present invention comprises the following steps:

Step S1: extracting a transaction total from an invoice;

Step S2: extracting a discount rate associated with the transaction total;

Step S3: calculating a rebate total based on the extracted transaction total and the extracted discount rate;

Step S4: sorting the calculated rebate total into numerical digits by currency subunits;

Step S5: enqueuing the sorted numerical digits into respective queues of the currency subunits; the value of each sorted numerical digit equals the additional queue number(s) enqueued to the respective queues of the currency subunits, wherein the queue number adds up on the previous queue number and increases in accordance with the order of natural numbers; and

Step S6: releasing one rebate to the buyer of the transaction associated with the n^{th} queue number once the current largest queue number reaches n times of the cycle number of the queue, wherein n is a natural number.

Using the rebate queue management system of the present invention, both offline and online transactions can be merged into one single process line and be enqueued to the same queue set for rebates. See the following with reference to FIG. 2 for greater detail.

As shown in FIG. 2, when an invoice is generated in the rebate queue management system, the first step is to extract the transaction total from that invoice. The extracted transaction total is multiplied by the corresponding discount rate offered by the seller to result the rebate total, which is then sorted by subunits of the currency to give numerical digits associated with the subunits. The sorted numerical digits are then enqueued to respective subunit queues. Please note that the sorted numerical digits may be in the range of 0 to 9, inclusive, wherein 0 could be ignored while enqueuing.

The queue number in each subunit queue increases upon the addition of any new numerical digit(s). The value, or the combined value, of the new numerical digits is/are the number of additional queue number(s) entering the queue, wherein the queue number adds up in accordance with the order of natural numbers. Once the number of the accumulated queue numbers reaches n times of the cycle number of the queue, wherein n is a natural number, one rebate is released. In other words, once a queue number becomes equal to the value of a rebate number, one rebate is released to the buyer associated with that queue number.

The rebate number of a queue number can be calculated according to the following Equation

L=INT(x/λ) (1)

wherein L is the rebate number, x is the current largest queue number, and λ is the cycle number of the queue.

That is, rebate number L is the integer portion of the ratio of largest queue number x to cycle number λ; the decimal portion of the ratio is automatically eliminated through the INT function.

The following provides a specific example to better demonstrate the operation of the rebate queue management system of the present invention.

A rebate queue platform XYZ implementing the rebate queue management system of the present invention supports rebate queuing functions of both online and offline transactions;

Buyer A spent $2,150 USD at a hotel (an offline seller under contract with XYZ platform);

Buyer B spent $15,800 USD at a training school (an offline seller under contract with XYZ platform) and $13,897,000 USD at a real estate company (an offline seller under contract with XYZ platform);

Buyer C spent $685 USD at X electronic mall;

Buyer D spent $352.25 USD at a shopping mall (an offline seller under contract with XYZ platform) and $6,890 USD at XX electronic mall.

According to the present invention, details of all the transactions of the above buyers (such as invoice numbers, membership information, transaction totals, seller's discount rates, etc.) would enter the XYZ platform and be further processed for rebate queuing. Assuming that the above transactions entered the XYZ platform in the order of Buyer A, B, C, and D, and that the contracted discount rate between XYZ platform and all the above online and offline merchants was 10%, the transaction and rebate details are described in the following table (Table 1):

TABLE 1

| | | | | Rebate Queuing Details | | | |
|---|---|---|---|---|---|---|---|
| | Invoice | Transaction | Rebate | Currency | | Current | Rebate |
| Entry | No. | Total (USD) | Total (USD) | Subunit | Rebate | Rebate No. | Status |
| 1 | 1001 | 2150 | 215 | One | 5 | | |
| | | | | Ten | 1 | | |
| | | | | Hundred | 2 | | |
| 2 | 1002 | 15,800 | 1,580 | One | 0 | | |
| | | | | Ten | 8 | | |
| | | | | Hundred | 5 | | |
| | | | | Thousand | 1 | | |
| | 1003 | 13,897,000 | 1,389,700 | One | 0 | | |
| | | | | Ten | 0 | | |
| | | | | Hundred | 7 | | |
| | | | | Thousand | 9 | | |
| | | | | Ten-thousand | 8 | | |
| | | | | Hundred- | 3 | | |
| | | | | thousand | | | |
| | | | | Million | 1 | | |
| 3 | 1004 | 685 | 68.50 | Hundredth | 0 | | |
| | | | | Tenth | 5 | | |
| | | | | One | 8 | | |
| | | | | Ten | 6 | | |
| 4 | 1005 | 352.25 | 35.23 | Hundredth | 3 | | |
| | | | | Tenth | 2 | | |
| | | | | One | 5 | | |
| | | | | Ten | 3 | | |
| | 1006 | 6,890 | 689 | One | 9 | | |
| | | | | Ten | 8 | | |
| | | | | Hundred | 6 | | |
| 5 | — | — | — | — | — | | |

As shown in Table 1, once the rebate total of each transaction is determined by multiplying the transaction total by the 10% discount rate, the amounts are sorted by each currency subunit to give numerical digits associated with the subunits. For example, Invoice 1001 relates to a rebate total of $215 USD, which can be sorted into 5 one-dollars, 1 ten-dollar, and 2 hundred-dollars; Invoice 1002 relates to a rebate total of $1,580 USD, which can be sorted into 0 one-dollar, 8 ten-dollars, 5 hundred-dollars, and 1 thousand-dollar; and Invoice 1003 relates to a rebate total of $1,389,700 USD, which can be sorted into 0 one-dollar, 0 ten-dollar, 7 hundred-dollars, 9 thousand-dollars, 8 ten-thousand-dollars, 3 hundred-thousand-dollars, and 1 million-dollar.

These sorted numerical digits are then enqueued to respective subunit queues in the order of the invoices were received, and the values of these sorted numerical digits are the number of additional queue numbers entering the respective subunit queues. Referring to Table 1, take Invoices 1001 to 1003 for example, 5 from Invoice 1001 is the numerical digit sorted to the ones subunit, so 5 new queue numbers are added to the one-dollar queue (0 can be ignored while enqueuing); 1 from Invoice 1001 and 8 from Invoice 1002 are the digits sorted to the tens subunit, so 9 new queue numbers are added to the ten-dollar queue; 2 from Invoice 1001, 5 from Invoice 1002, and 7 from Invoice 1003 are the digits sorted to the hundreds subunit, therefore 14 additional queue numbers are enqueued to the hundreds queue; likewise, 1 from Invoice 1002 and 9 from Invoice 1003 are the digits sorted to the thousands subunit, therefore 10 new queue numbers are enqueued to the thousand-dollar queue. Same rationale applies to the other transactions and currency subunits exemplified in Table 1.

After the above sorting and queuing, individual rebates are released once the respective subunit queues satisfy the predetermined rebate condition, which in the example described in Table 1 is when the number of the accumulated queue numbers reaches n times of the cycle number of the rebate queue, wherein n is a natural number; in other words, once a queue number becomes equal to the rebate number of the current largest queue number, as determined by using Equation (1), one rebate is released to the buyer associated with that queue number.

Referring again to Table 1, the transaction total extracted from Invoice 1002 is $15,800 USD, which is multiplied by the 10% seller's discount rate to give a rebate total of $1,580 USD. This rebate total can be sorted by the currency subunits to result: the numerical digit relating to the thousands subunit is 1, the digit relating to the hundreds subunit is 5, the digit relating to the tens subunit is 8, and the number relating to the ones subunit is 0. Since 0 is ignored in enqueuing, only the three digits 1, 5, and 8 are enqueued to the thousand-dollar queue, hundred-dollar queue, and ten-dollar queue, respectively.

Therefore, in the thousand-dollar queue, assuming that the previous queue number was n, 1 new number (queue number n+1) is enqueued, and the current largest queue number becomes n+1;

In the hundred-dollar queue, assuming that the previous queue number was m, 5 new numbers (queue numbers m+1, m+2, m+3, m+4, and m+5) are enqueued, and the current largest queue number becomes m+5;

In the ten-dollar queue, assuming that the previous queue number was h, 8 additional numbers (queue numbers h+1, h+2, h+3, h+4, h+5, h+6, h+7, and h+8) are enqueued, and the current largest queue number becomes h+8.

To better explain the following rebate process, referring now to the above ten-dollar queue only. Assuming that the cycle number λ was 10 and the previous queue number h was 28, the current largest queue number h+8 would be 36 and the corresponding rebate number L would be INT(36/10)=3. This indicates that when the current largest queue number becomes 36, one rebate should be released to the buyer of the transaction associated with the 3^{rd} queue number. Same rationale applies to all subsequent transactions. For example, assuming that more numbers have later entered the ten-dollar queue and the current largest queue number became 290, the rebate number L would be INT(290/10)=29, which equals the value of h+1, which means one rebate can be released to Invoice 1002, and thus Buyer B in this example.

Based on the above rationale, since Invoice 1002 has a total of 8 queue numbers in the ten-dollar queue (queue number h+1=29, h+2=30, h+3=31, h+4=32, h+5=33, h+6=34, h+7=35, and h+8=36), Buyer B will have 8 chances of receiving rebate from the ten-dollar subunit queue (in other words, 8 one-hundred-dollar rebates). Note that other subunit queues are operated in a parallel manner; as a result, in addition to 8 queue numbers in the ten-dollar queue, Invoice 1002 also has 5 queue numbers in the hundred-dollar queue (that is, 5 one-thousand-dollar rebates) and 1 queue number in the thousand-dollar queue (that is, 1 ten-thousand-dollar rebate). Therefore, as long as new invoices continue to enter the queues, the entire amount of the transaction associated with Invoice 1002 (that is, $15,800 USD) will eventually be returned to Buyer B in the form of cash, virtual currency, or credit.

The cycle number of the present invention is not limited to 10; the cycle number is adjustable according to different sellers' needs. If the cycle number λ in the above example was 7 and the previous queue number in the ten-dollar queue h was again 28, the current largest queue number h+8 would still be 36, but the corresponding rebate number L would become INT(36/7)=5. This means that when the current largest queue number becomes 36, one rebate should be released to the buyer of the transaction associated with the 5^{th} queue number. Note that once the cycle number is determined, all subunit queues will be subject to the same cycle number.

Furthermore, the discount rates offered by the merchants are not limited to 10% and may fall in the range of 0.1%-99.9% (such as, 1%, 3%, 5%, 8%, 20%, 30%, 40%, 50%, etc.). Take a 20% discount rate for example, the rebate total of a $2,150 USD transaction is $430 USD, which implies 4 chances of receiving rebate from the hundred-dollar queue (in other words, 4 one-thousand-dollar rebates) and 3 chances of receiving rebate from the ten-dollar queue (in other words, 3 one-hundred-dollar rebates); as a result, the total rebate will be $4,300 USD, which is double the amount of the original transaction. Therefore, higher discount rates yield higher rebate totals.

Utilizing the system and method of the present disclosure as described in the above example, buyers need not change their usual purchasing habits and can receive particularly enticing amounts of rebates in a timely manner.

Moreover, transactions of different discount rates may be processed in the same queue, and each transaction would receive rebates associated with respective discount rates. For instances where few large transactions occur in the queue (for example, Invoice 1003 in Table 1 has a transaction total of $13,897,000 USD, which corresponds to a rebate total of $1,389,700 USD under a 10% discount rate), one may divide the amounts in large subunits into a smaller one by using the upper-limit setup unit to define a subunit as the upper-limit, which may include thousand, ten-thousand, hundred-thousand, million, ten-million, hundred-million, etc.; the divided amounts are then enqueued to the subunit queue of the upper-limit. In this way, less-occurring large transactions can be enqueued with other more-commonly-seen smaller transactions and be processed for rebates more promptly.

Take Invoice 1003 in Table 1 for example, the total of rebate is $1,389,700 USD, which equals 7 additional queue numbers in the hundred-dollar queue, 9 additional queue numbers in the thousand-dollar queue, 8 additional queue numbers in the ten-thousand-dollar queue, 3 additional queue numbers in the hundred-thousand-dollar queue, and 1 additional queue number in the million-dollar queue. Since transactions involving a million-dollar subunit may be relatively rare, hundred-thousands could be set as the subunit of the upper-limit. As a result, the 1 queue number in the million-dollar queue divides into 10 queue numbers in the hundred-thousand-dollar queue and can be enqueued with the 3 other hundred-thousand-dollar queue numbers already in line, which results in 13 queue numbers in the hundred-thousand-dollar queue for Invoice 1003. In this way, the wait time for large transactions to receive large rebates are significantly reduced.

In addition to combining transactions in one queue, the rebate queue management system of the present invention may also generate queues of different price intervals (for example, $1-1,000 USD, $1000-10,000 USD, $10,000-100,000 USD, over $100,000 USD) and/or different merchandise categories (such as, clothing, digital products, home appliances, books, food, etc; or, digital products between $1-1,000 USD, home appliances between $1,000-10,000 USD, etc). In this way, the differences in rebate amounts between different transactions in the same queue can be controlled, so that the rebate process can stay in a pace that keeps buyers interested in making more transactions.

Likewise, the basic currency subunits used in the rebate queue management system of the present invention may be adjusted based on different currency values. For currencies having smaller currency values, such as the Japanese yen, the smallest subunit chosen may be the hundred-yen.

Similarly, at least one special number can be preset in the subunit queues by the special number setup unit. Buyer associated with a special number may skip the queue and receive an immediate rebate if his/her queue number is one of the special numbers. A special number may be a common lucky number (such as 4, 7, 44, 77, 444, 777, or numbers ending with a 77, etc.) or a number that labels a scale shift in the number of rebate queue participants (such as, the 1,000^{th}, 10,000^{th}, 100,000^{th}, 1,000,000^{th} queue number). These numbers are merely exemplary and may be adjusted for different needs. This embodiment offers an “express checkout” option, which prompts buyers to logon to the system and check their rebate queue statuses more frequently, as well as stimulates buyers' purchasing desire. Note, however, that the system does not twice rebate the buyer when that queue number later becomes qualified for a rebate under regular queuing conditions.

Additionally, if a transaction involves a currency that is different from the common currency used in the area, the currency conversion unit would convert the currency of that transaction to the common currency, based on the real-time currency exchange rate. Similarly, the common currency is converted back to the currency of the original transaction based on the real-time currency exchange rate before releasing the rebate to the buyer.

For example, assuming that a transaction total in an invoice was [symbol] 1,000 euro but the common currency used in the area was the US dollar, the rebate total for the transaction under a 10% discount rate would be [symbol] 100 euro, which converts to $132 USD (assuming that the real-time Euro-to-USD exchange rate was 1:1.32). Numerical digits sorted from the $132 USD may then be enqueued to the hundred-dollar, ten-dollar, and one-dollar subunit queues. Once the transaction becomes qualified for rebates, each $1000 USD in the hundred-dollar queue would convert to [symbol] 769.23 euro, each $100 USD in the ten-dollar queue would convert to [symbol] 76.92 euro, and each $10 USD in the one-dollar queue would be convert to [symbol] 7.69 euro (assuming that the real-time Euro-to-USD exchange rate was 1:1.30) before releasing the rebates to the buyer.

As a result, invoices involving different currencies may all join the same queue sets for rebates, which creates additional convenience to buyers from around the world.

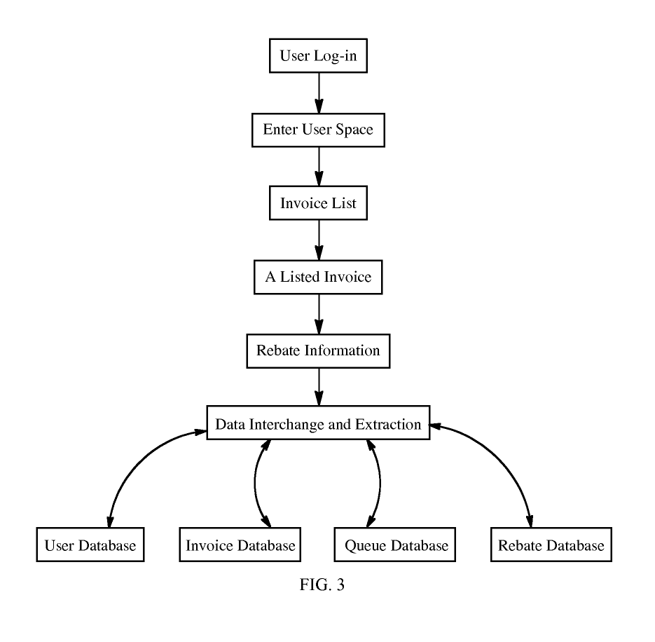

Referring now to FIG. 3, which is a flow chart describing a method of retrieving user's rebate records in accordance with an embodiment of the present invention. As shown in FIG. 3, upon completion of account registration, users may enter their own user space, where they can access a list of their invoices and the transaction details in each invoice. Each invoice would hyperlink the users to a Rebate window showing the current queue and rebate statuses of that invoice, which may include paid (meaning rebates of all subunit queues have released), partially paid (meaning rebates of some of the subunit queues have released), and unpaid (meaning no rebate of neither subunit queues has released). This straightforward approach keeps the users posted on all their rebate queue statuses.

In addition, user database, invoice database, queue database, and rebate database are used to store data on user information, invoice details, queue records, and rebate records, respectively. These data can be used in or obtained through rebate calculation. The queue and rebate statuses obtained through the calculation can be displayed on the Rebate window mentioned above.

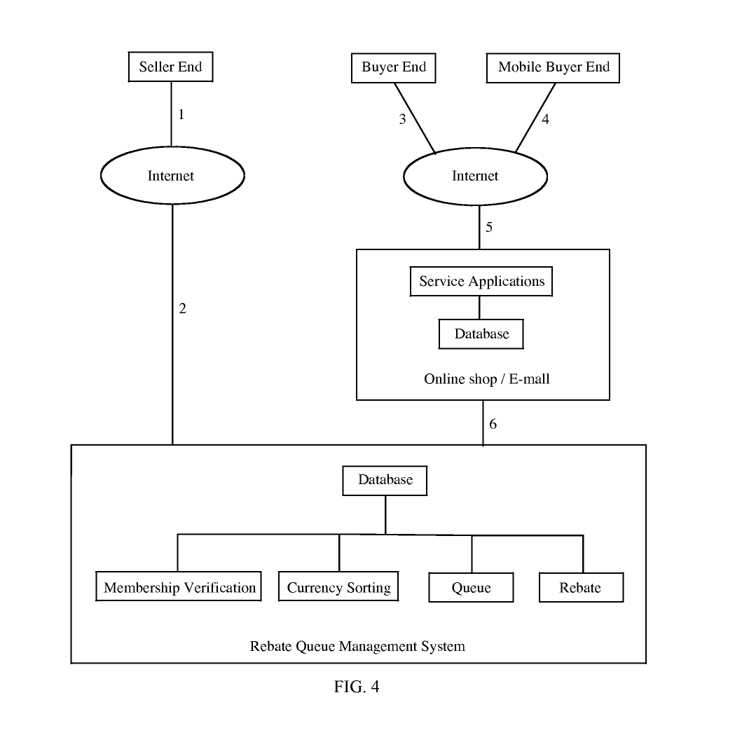

Referring now to FIG. 4, which schematically illustrates the online and offline transaction procedures according to the rebate queue management system of the present invention. As shown in FIG. 4, offline customers (buyers) may complete their membership verification and payment at the seller end (Procedure 1), data on the offline transactions are then sent to the rebate queue management system via the Internet (Procedure 2); meanwhile, online customers (buyers) may connect to the Internet from desktop computers at the buyer end (Procedure 3) or smartphones or tablet computers at the mobile buyer end (Procedure 4), and complete their membership verification and payment at online shops or e-malls (Procedure 5); these online transactions are then sent to the rebate queue management system via the Internet or private networks (Procedure 6).

With further reference to FIG. 4, servers and databases are installed at the online shops or e-malls; the servers are used for applications, such as membership verification and payment, and the databases are used to store relevant transaction data, such as invoice numbers, membership information, transaction totals, discount rates, rebate rates, etc. Similarly, the rebate queue management system may equip with servers and databases, wherein the servers are used for membership verification, currency sorting, queuing, and rebate, and the databases are used to store the relevant information. Databases may be installed either inside of the server or independently from the server.

In at least one embodiment of the present invention, units of the rebate queue management system may include circuits configured to execute the required programs provided by appropriate media. For example, units of the rebate queue management system may implement one or more processor(s), and/or other mechanisms configured to execute executable instructions (such as software and/or hardware instructions), and/or hardware circuits. An exemplary embodiment of the units of the rebate queue management system may include, but not limited to, hardware logic, PGA (programmable gate array), FPGA (field programmable gate array), ASIC (application specific integrated circuit), status machine, and/or other mechanisms or combinations with the processors.

In some embodiments of the present invention, units of the rebate queue management system may include storage circuit or external storage circuit (figure not shown). Storage circuit is configured to store programs, such as executable codes or instructions for software and/or hardware, digital data, database, or other digital information, and may include processor-usable medium. The processor-usable medium may implement any computer program products or manufactures capable of the inclusion, storage, or maintenance of programs, data, and/or digital information, which may be used by, or associated with, the instruction execution system for units of the rebate queue management system of the exemplary embodiments. An exemplary processor-usable medium may comprise any one of the physical media, including electrical, magnetic, optical, electromagnetic, infrared, or semiconductive medium. More specifically, a processor-usable medium may include, but not limited to, portable computer disc, such as softdisk, compressed (zip) disk, hard drive, random access memory (RAM), read only memory (ROM), flash memory, cache memory, and/or other configurations capable of storing programs, data, or other digital information.

At least some embodiments described in the present disclosure can be realized by using programs which store in the appropriate storage circuits described above and are configured to control the appropriate units in the rebate queue management system. Appropriate medium, including the medium implemented in manufactures, may be used to provide these programs.

Moreover, user interfaces at the seller end and the buyer end are configured in an interactive setting, which may include display monitors, audio output devices, touch screens for data entries, and voice command system. For example, the user interface in one embodiment of the present invention uses display monitor to show the current queue and rebate conditions to its user.

To sum up, the present invention simplifies the rebate queuing procedure and reduces the unnecessary connections and disconnections between websites; thus, the straightforwardness, convenience, and efficiency of an e-commerce platform can be realized through the present invention, and the platform users can have faster and safer shopping experiences. Besides, the present invention can effectively process transactions of different categories and different prices, and combines online and offline transactions, which fully realizes the integration of rebate systems and methods for online and offline transactions of different merchandise categories and prices. Buyers need not change their usual purchasing habits to receive rebates in a timely manner.

Additionally, the present invention combines the features of currency values with transactions and rebates, and makes the calculation of rebates simpler, faster, and highly operable.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

Furthermore, while certain features of the invention have been illustrated and described herein, many modifications, substitutions, changes, and equivalents may occur to those skilled in the art. It will be, therefore, apparent to those skilled in the art that various modifications and variations can be made to the embodiments of the disclosure without departing from the scope of the invention. Other embodiments of the invention will be apparent to those skilled in the art from consideration of the specification and practice of the invention disclosed herein. It is intended that the specification and examples be considered as exemplary only.

We claim:

1. A rebate queue management system, comprising:
a seller end to: communicate with sellers via the Internet; and receive data on transaction details and discount rates sent from said sellers;
a buyer end to: communicate with buyers via the Internet;
a payment module end to: communicate with payment modules with online banking capability via the Internet;
a transaction extraction unit coupled to said seller end to: extract a transaction total from an invoice;
a discount extraction unit coupled to said seller end to: extract a discount rate associated with said transaction total;
a rebate calculation unit coupled to said transaction extraction unit and said discount extraction unit to: calculate a rebate total based on said transaction total and said discount rate;
a sorting unit coupled to said rebate calculation unit to: sort said rebate total into numerical digits by subunits of a currency;
a queue unit coupled to said sorting unit to: enqueue said numerical digits to a queue set;
respective queues grouped according to said subunits of said currency; at least 0 queue numbers and a cycle number comprised in said respective queues; value of said numerical digits equals said queue numbers enqueued to said respective queues; and
a rebate unit coupled to said queue unit to: release a rebate to a buyer associated with an n^{th} queue number once said queue number accumulates to n times of said cycle number of said respective queues, wherein n is a natural number.

2. The system of claim 1, wherein said sorting unit sort said rebate total by subunits of a currency comprising: hundredth, tenth, one, ten, hundred, thousand, ten-thousand, hundred-thousand, million, ten-million, hundred-million, and billion.

3. The system of claim 1, wherein:
said cycle number is any natural number that is larger than 1; and said discount rate falls within the range of 0.1%-99.9%, inclusive.

4. The system of claim 1, wherein said rebate comprising: cash, virtual currency, and credit.

5. The system of claim 1, further comprising:
an upper-limit setup unit coupled to said sorting unit to: define a subunit as an upper-limit, wherein said upper-limit comprising: thousand, ten-thousand, hundred-thousand, million, ten-million, and hundred-million;
said numerical digits associated with subunits that are larger than said upper-limit are divided and sorted into said upper-limit and enqueued to a queue associated with said upper-limit.

6. The system of claim 1, further comprising:
a special number setup unit coupled to said queue unit to: preset at least one special number in one or more of said respective queues;
once said queue number reaches one of said special numbers, one rebate is released to a buyer associated with said queue number; said buyer does not receive a second rebate when said queue number later becomes qualified for a rebate under regular queuing conditions.

7. The system of claim 1, further comprising;
a currency conversion unit coupled to said transaction extraction unit and said rebate unit to: convert a currency to a common currency based on real-time currency exchange rates when a transaction of a buyer extracted by said transaction extraction unit involves said currency that is different from said common currency; and
convert said common currency back to said currency based on real-time currency exchange rates before releasing a rebate to said buyer by said rebate unit.

8. The system of claims 1-7, wherein
said seller end comprising: hardware on said seller end and software on said seller end implemented on said hardware on said seller end; said hardware on said seller end include desktop computers, tablet computers, and POS devices; said software on the seller end include computer-executable programming codes associated with customer information inquiries, transaction inquiries, generation and delivery of invoices, rebate inquiries, and relevant statistical analyses;
and wherein said buyer end comprising: hardware on said buyer end and software on said buyer end implemented on said hardware on said buyer end; said hardware on the buyer end include desktop computers, tablet computers, and smartphones; said software on the buyer end include computer-executable programming codes associated with addition, deletion, revision, and tracking of information on membership accounts, transaction inquiries, and rebate inquiries.

9. The system of claims 1-7, wherein
said seller end comprises online and offline transactions from said seller end to: verify customer's membership status and upload transaction details;
and wherein said buyer end comprises an input device to: enter account information, purchasing records, and search terms, and a display device to: display transaction details, queue status and rebate status.

10. A computer-implemented method for managing rebate queues, comprising the steps of:
extracting a transaction total from an invoice;
extracting a discount rate associate with said transaction total;
calculating a rebate total based on said transaction total and said discount rate;
sorting said rebate total into numerical digits by subunits of a currency;
enqueuing said numerical digits to a queue set;
respective queues grouped according to said subunits of said currency; at least 0 queue numbers and a cycle number comprised in said respective queues; value of said numerical digits equals said queue numbers enqueued to said respective queues; and
releasing a rebate to a buyer associated with an n^{th} queue number once said queue number accumulates to n times of said cycle number of said respective queues, wherein n is a natural number.

11. The method of claim 10, wherein sorting said rebate total by subunits of a currency comprising: hundredth, tenth, one, ten, hundred, thousand, ten-thousand, hundred-thousand, million, ten-million, hundred-million, and billion.

12. The method of claim 10, wherein
said cycle number is any natural number that is larger than 1; and said discount rate falls within the range of 0.1%-99.9%, inclusive.

13. The method of claim 10, wherein said rebate comprising: cash, virtual currency, and credit.

14. The method of claim 10, further comprising the step of:
defining a subunit as an upper-limit, wherein said upper-limit comprising: thousand, ten-thousand, hundred-thousand, million, ten-million, and hundred-million;
said numerical digits associated with subunits that are larger than said upper-limit are divided and sorted into said upper-limit and enqueued to a queue associated with said upper-limit.

15. The method of claim 10, further comprising the step of:
presetting at least one special number in one or more of said respective queues;
once said queue number reaches one of said special numbers, one rebate is released to a buyer associated with said queue number; said buyer does not receive a second rebate when said queue number later becomes qualified for a rebate under regular queuing conditions.

16. The method of claim 10, further comprising the step of:
converting a currency to a common currency based on real-time currency exchange rates when a transaction of a buyer involves said currency that is different from said common currency; and
converting said common currency back to said currency based on real-time currency exchange rates before releasing a rebate to said buyer.
